(19) United States
(12) Patent Application Publication
(10) Pub. No.: US 2025/0383225 A1
(43) Pub. Date: Dec. 18, 2025

(54) DEVICE FOR MONITORING A LIQUID IN A CONTAINER

(71) Applicant: THE SMART CONTAINER COMPANY LIMITED, Treforest (GB)

(72) Inventors: Eduardo GARCIA, Treforest (GB); Stephen Andrew COLE, Treforest (GB)

(21) Appl. No.: 18/880,178

(22) PCT Filed: Jun. 28, 2023
(86) PCT No.: PCT/GB2023/051687

§ 371 Date: Dec. 30, 2024

(30) Foreign Application Priority Data
Jun. 28, 2022 (GB) 2209483.3

(51) Int. Cl. G01F 23/296; G01F 23/2962

(52) U.S. Cl. CPC G01F 23/2968; G01F 23/2962

(57) ABSTRACT

A device (100) for monitoring a liquid in a container (10) comprises a device housing (110), a transducer unit (120) with a transducer (130), a resilient wave guide (140, 142), and a controller (150). The device housing (110) is configured to be mounted to an external surface (20) of the container (10). The transducer (130) is configured to emit sound waves or electromagnetic waves through the external surface (20) to the liquid and to receive reflections of the emitted waves at the air-liquid interface. The resilient wave guide (140, 142) has a top surface arranged to contact the transducer (130) and a bottom surface arranged to contact the external surface (20) of the container (10). The transducer unit (120) is configured to enable the transducer (130) to travel from a disengaged state to an engaged state, wherein the transducer (130) is closer to the external surface (20) when in the engaged state than when in the disengaged state. The controller (150) is operatively coupled to the transducer (130) to control the transducer (130) and to process the received reflections.

### TECHNICAL FIELD

The present invention relates to a device for monitoring a liquid in a container, the device comprising housing configured to be mounted to an external surface of the container, and a transducer configured to emit sound waves or electromagnetic waves through the external surface to the liquid and to receive reflections of the emitted waves at the liquid. The invention further relates to a liquid container equipped with such a sensor.

### BACKGROUND

Draught beer and other beverages, such as wine, milk, kombucha, cider, cocktails, ale, are often stored and transported in containers, kegs, or barrels. Such containers may be connectable to a dispense system for the controlled release of distinct amounts of the liquid. Other liquids that may be stored in containers, kegs, or barrels include crude oil or vegetable oils. If the container walls are opaque, it is difficult to determine how much liquid is stored inside. When the container walls are transparent, it may be easier to visually establish a filling level of the container, but other qualities of the stored liquid, such as its colour or temperature, may still be difficult to observe. Furthermore, it may be desirable to monitor filling levels and other relevant parameters at regular intervals and over longer periods. The data obtained through the monitoring process may be stored locally or remotely and used for commercial analysis or quality control.

An example of a sensor system for monitoring the content of a keg is, for example, described in the GB patent application published as GB 2 585 228 A. In that patent application, a monitoring device is attached to the rim and upper surface of the keg. The monitoring device comprises an ultrasonic transducer that is configured to measure the volume of the liquid inside the keg. The monitoring device is designed such as to allow the transducer to be in direct contact with the stainless steel of the bottom end surface of a keg, distanced from the side walls of the keg. This positioning facilitates a clear path for an ultrasonic signal to be sent across the length of the keg. The monitoring device may comprise two or more ultrasonic transducers to improve the reliability and the accuracy of the measurement.

It is an aim of the present invention to further improve the liquid monitoring device and to provide for an even more reliable and accurate monitoring of the liquid inside the container.

### SUMMARY OF THE INVENTION

According to an aspect of the invention there is provided a device for monitoring a liquid in a container, the device comprising a device housing, a transducer unit comprising a transducer, a resilient wave guide, and a controller. The device housing is configured to be mounted to an external surface of the container. The transducer is configured to emit sound waves or electromagnetic waves through the external surface to the liquid and to receive reflections of the emitted waves at the liquid, i.e., at the liquid level or at an air-liquid interface. The resilient wave guide has a top surface arranged to contact the transducer and a bottom surface arranged to contact the external surface of the container. The transducer unit is configured to enable the transducer to travel from a disengaged state to an engaged state, wherein the transducer is closer to the external surface when in the engaged state than when in the disengaged state. The controller is operatively coupled to the transducer to control the transducer and to process the received reflections.

It has been observed that, when using this type of transducer to monitor liquids inside containers, it is very important for the transducer to be immobile relative to the external surface of the container. With the monitoring device according to the invention the desired immobility is achieved by an interplay between the resiliency of the wave guide and the transducer unit's translation into the engaged state. When moving the transducer unit into its engaged state, it is pushed into the resilient wave guide. As a reaction, the resilient wave guide pushes back against the transducer unit to keep it firmly in place and ensure the optimal functioning of the transducer.

The transducer unit may be configured such that it can be engaged once after the monitoring device has been installed, e.g. immediately after mounting the device housing to the container or after the container has been filled with liquid for the first time. In preferred embodiments, the transducer unit is configured to enable the transducer to repeatedly travel back and forth between the engaged state and the disengaged state. This brings, for example, the possibility to disengage the transducer when the container is not in use and may avoid unnecessary data gathering. Furthermore, it makes it possible to disengage the transducer, dismount the monitoring device and attach it to a different container for monitoring the liquid stored therein. Consequently, the monitoring device can be used repeatedly with different containers.

The transducer unit may comprise a stationary portion, fixedly connected to the device housing, and a mobile portion, movingly coupled to the stationary portion, and mechanically coupled to the transducer, such that the transducer is brought to the engaged state by moving the mobile portion relative to the stationary portion. The resilient wave guide may be primarily located inside the stationary portion, such that the movement of the mobile portion results in the transducer pushing the resilient wave guide more firmly against the external surface of the container.

In some embodiments, the transducer may be brought to the engaged state by a linear movement of the mobile portion relative to the stationary portion. For example, the mobile portion may be embodied as a push button that is pushed down over or inside the stationary portion to bring the transducer into the engaged state. The mobile portion and/or the stationary portion may comprise one or more latches to ensure that the stationary portion can only be moved into one direction. The latches may be disengageable to allow the mobile portion to move back into its original configuration wherein the transducer is disengaged.

In preferred embodiments, the transducer is brought to the engaged state by a rotational movement of the mobile portion relative to the stationary portion. for example, the stationary portion and the mobile portion are coupled via a snail cam coupling or a screw coupling. When the transducer is in the engaged state, the resilient wave guide may exert an inherent spring force onto the mobile portion. Preferably, the material properties and the geometry of the stationary portion and the mobile portion are such that the surface friction between the two portions is sufficient to withstand the spring force of the resilient wave guide. Optionally, one or more spring elements may be installed between the device housing and the mobile portion to bias the mobile portion towards the stationary portion.

When the transducer is brought to the engaged state by a rotational movement of the mobile portion, it is preferred that the mobile portion and the transducer are mechanically coupled in such a way that the transducer does not rotate together with the mobile portion. While, for example, a screw coupling or snail cam coupling gradually moves the mobile portion downward during the rotational movement of the mobile portion, the transducer is pushed down by the mobile portion without joining the rotational movement. This brings the technical advantages that the transducer will not exert a torque on the resilient wave guide and that any wiring that may be connected to the transducer is not rotated relative to the device housing. If, for example, the controller or a battery for powering the monitoring device are positioned in a stationary part of the device housing, avoiding rotational movement of the transducer reduces the risk of damaging the wiring during engagement or disengagement of the transducer.

In preferred embodiments, the transducer is held in a transducer casing, the transducer casing and the stationary portion together comprising at least one cooperating ridge and groove for guiding a linear motion of the transducer casing relative to the stationary portion. The groove and ridge help to ensure that the transducer casing cannot rotate relative to the stationary portion and all movement will be in a straight line toward or away from the resilient wave guide.

The resilient wave guide may comprise an elastomer, such as silicone, to provide the required resiliency. The wave guide may, for example, be fully formed by the elastomer or comprise a solid core, overmoulded with the elastomer at one or both of its contact surfaces. The solid core may, e.g., be made of a rigid plastic that is transparent for the sound waves or electromagnetic waves used by the transducer.

In preferred embodiments, the transducer is configured to emit ultrasonic waves. Ultrasound has been proven to be very suitable for measuring liquid levels in a metal container.

Preferably, the device for monitoring a liquid further comprises a wireless communication unit, operationally coupled to the controller for transmitting data based on the received reflections. The wireless communication may, for example, involve Bluetooth, Wi-Fi, 3G, 4G, and/or 5G communication. Wireless communication allows for storing the monitoring data remotely and using real-time updates of the container for improved stock management and logistics. The real-time updates further make it possible to monitor consumption. Every time some of the liquid from the container is dispensed, the wireless communication unit may be used to inform a nearby or remote monitoring system about the changed liquid level inside the container.

According to a further aspect of the invention, a container is provided for storing a liquid, the container comprising a device for monitoring the liquid as described above. The device housing of the device for monitoring the liquid may, for example, be mounted to an top or bottom surface of the container.

### BRIEF DESCRIPTION OF THE DRAWINGS

Embodiments of the invention will now be described by way of example with reference to the accompanying drawings, in which:

FIG. 1 shows a keg to which a monitoring device may be attached.

FIG. 2 shows a top view of an installed monitoring device according to an embodiment of the invention.

FIG. 3 shows a partial cross section of the monitoring device of FIG. 2.

FIG. 4 shows a partial cross section of another embodiment of the monitoring device according to the invention.

FIG. 5a shows a perspective view of the monitoring device of FIG. 4.

FIG. 5b shows a perspective view of the monitoring device of FIG. 4, with the stationary portion of the transducer unit removed.

FIG. 6 shows three different configurations of the transducer unit of the monitoring device of FIGS. 2 to 5.

### DETAILED DESCRIPTION

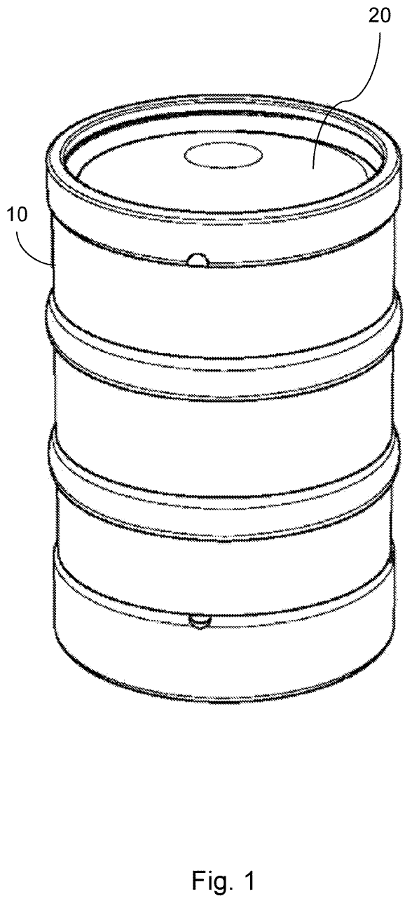

FIG. 1 shows a keg 10 to which a monitoring device 100 may be attached. The keg 10 may be used for storing, and possibly dispensing, draught beer or other beverages. Alternatively, the monitoring device 100 may be used with oil drums or other liquid-containing containers. The keg 10 shown here comprises a cylindrical wall, a bottom surface and a top surface 20. Typically, the keg 10 will be made of steel or another metal. Alternatively, the keg 10 may be made of, e.g., plastic.

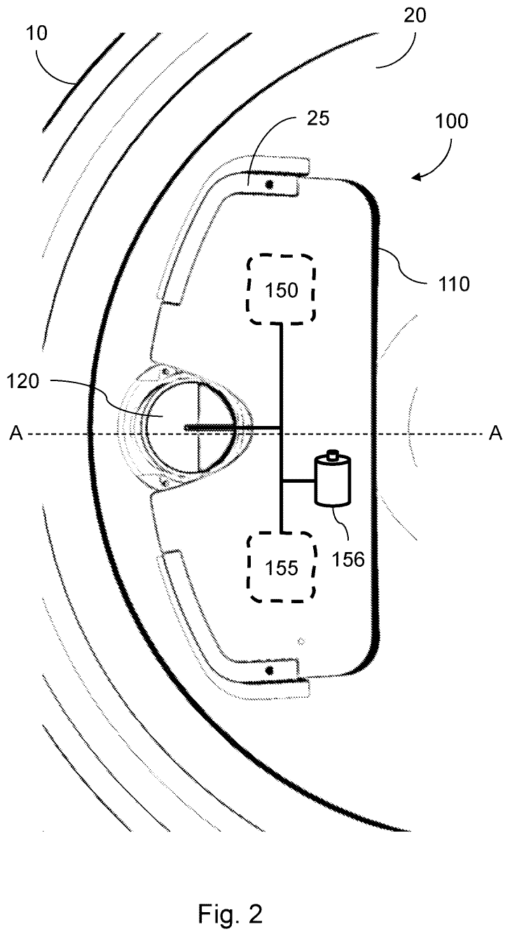

FIG. 2 shows a top view of an installed monitoring device 100 according to an embodiment of the invention. In this exemplary embodiment, the monitoring device 100 is mounted to the top surface 20 of the keg 10. In other embodiments, the monitoring device 100 may be mounted to the bottom surface of the keg 10. For a direct line of sight to the air-liquid interface that represents the liquid level, and for minimal disturbance of the emitted and reflected wave signals, the monitoring device 100 is preferably located at a position away from the container walls. Similarly, and for the same reasons, an optimal location may stay sufficiently far away 35 from the dispensing system that is typically located at the centre of the keg. The monitoring device 100 comprises a device housing 110 that is held to the top surface 20 by two brackets 25 that may be welded to the keg 10. The device housing 110 may, for example, be held in position by screwing it to the brackets 25. Alternatively, or additionally, the bottom of the device housing 110 may be glued to the top surface 20 of the keg 10.

The monitoring device 100 may be activated by pushing a transducer unit 120 down onto the keg surface 20. Alternatively, the monitoring device 100 may comprise a separate activation button, or an activation signal may be received from a nearby or remote device. ‘Down’ is herein interpreted as towards the keg's top surface 20 when the keg 10 is in an upright position and the monitoring device 100 is attached to its top surface 20. If the monitoring device 100 is attached to the bottom of the keg 10, the transducer unit 120 will be pushed upwards (relative to the keg 10) when engaged.

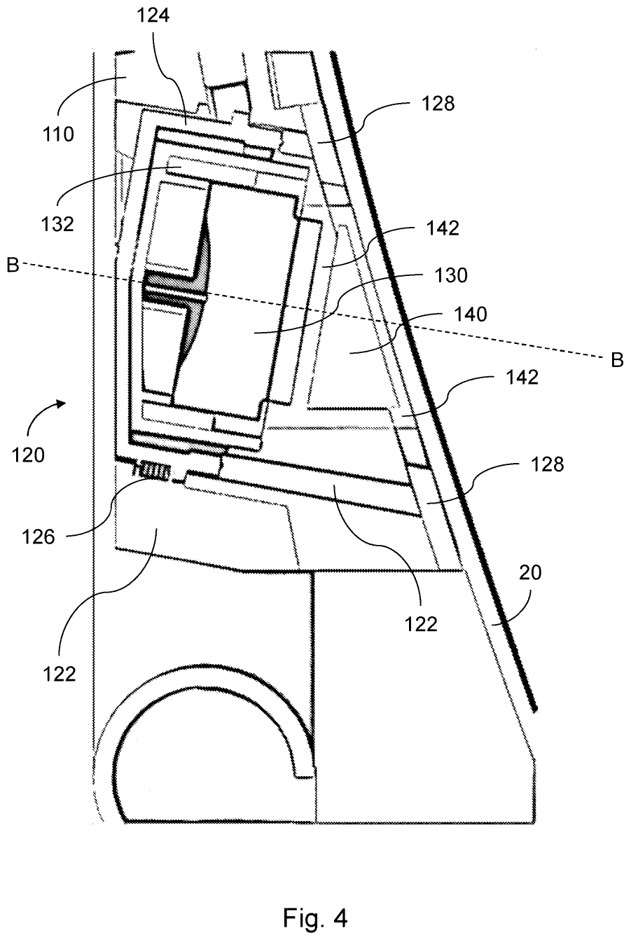

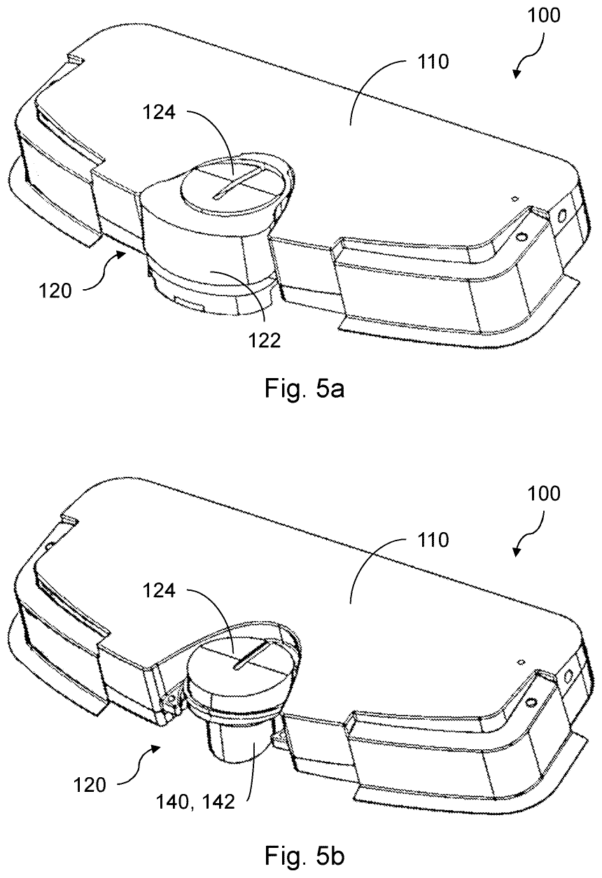

The transducer unit 120 comprises the transducer 130 and a mechanism for bringing the transducer 130 into the engaged state. Exemplary embodiments of this mechanism are discussed in more detail below with reference to FIGS. 4 and 5. In preferred embodiments, the transducer 130 is configured to emit ultrasonic waves. Ultrasound has been proven to be very suitable for measuring liquid levels in a metal container. In some embodiments, the transducer 130 may further be used for monitoring other aspects of the container content, such as carbonation levels of the stored liquid.

The transducer may be powered by a power source, such as one or more batteries 156, and controlled by a controller 150. Preferably, the controller 150 and the power source 156 are both housed inside the device housing 110. If small enough, the power source 156 and/or the controller 150 may be housed in the transducer unit 120. In some embodiments, additional sensors may be coupled to the controller 150 for monitoring, e.g., carbonation levels, air pressure, a temperature of the liquid, or a temperature in the immediate surroundings of the container 10. Such additional sensors may be embedded in the same device housing 100, or provided separately while being operationally coupled to the controller via a wired or wireless connection.

A wireless communication unit 155 may be integrated within or coupled to the controller 150 for transmitting sensor data to a remote location. Additionally, the communication unit 155 may be used to receive instructions or update the controller firmware. The wireless communication may, for example, involve Bluetooth, Wi-Fi, 3G, 4G, and/or 5G communication. Wireless communication allows for storing the monitoring data remotely and using real-time updates of the container for improved stock management and logistics. Alternatively or additionally, a communication port (not shown) may be provided in the device housing 110, allowing for a cable connection to the controller 150.

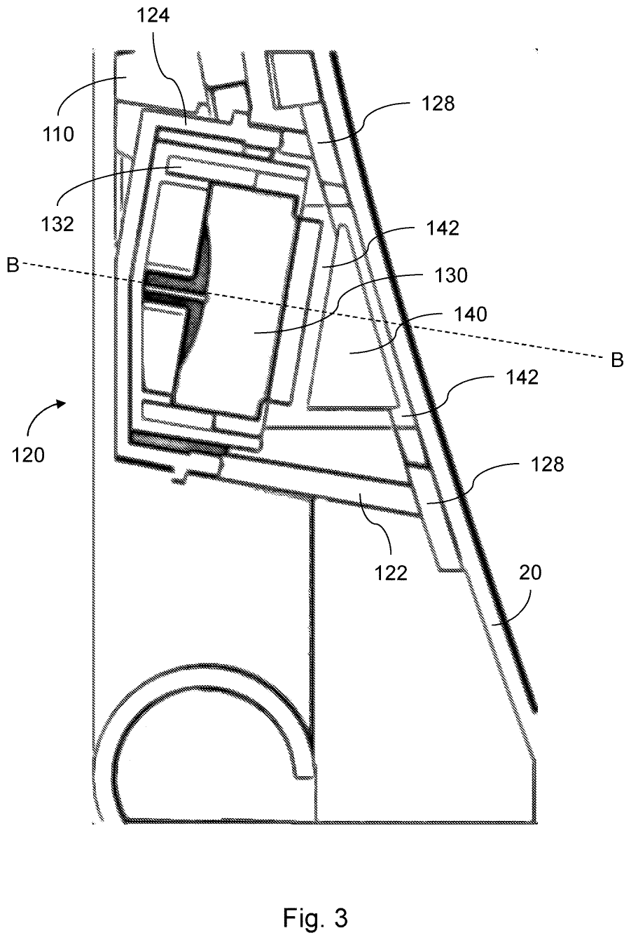

FIG. 3 shows a partial cross section of the monitoring device 100 of FIG. 2. The cross section is made at the line A-A, indicated in FIG. 2. In this cross section, the transducer unit 120 can be seen to have a lower stationary portion 122 and an upper mobile portion 124. In this embodiment, the stationary portion 122 rests on a foot 128 that is in direct contact with the upper keg surface 20. In other embodiments, the stationary portion 122 may be placed directly on the keg surface 20. The transducer 130 is held in a transducer casing 132 that loosely fits inside the mobile portion 124.

A resilient wave guide 140, 142 is situated in between the transducer 130 and the keg surface 20. The resilient wave guide 140, 142 used in this embodiment consists of a rigid and solid block 140 of, e.g., plastics, overmoulded with a silicon covering 142. Different elastomers or other resilient coverings may be used for the covering 142. In other embodiments, the resilient wave guide may be a unitary body of resilient material, or comprise a hollow body. The materials used in the resilient wave guide 140, 142 are selected such that they effectively conduct the sound waves or electromagnetic waves coming from the transducer 130 towards the keg surface 20, and the waves reflected at the air-liquid interface inside the container 10 from the keg surface 20 back to the transducer 130.

The stationary portion 122 and the mobile portion 124 of the transducer unit 120 are coupled in such a way that a movement of the mobile portion 124, relative to the stationary portion 122 results in a downward or upward movement of the mobile portion 124 relative to the keg surface 20, thereby bringing the transducer 130 closer to, respectively further away from, the keg surface 20. Optionally, the movement of the mobile portion 124 triggers an on/off switch that ensures that no battery power is wasted when the transducer is up in its disengaged state.

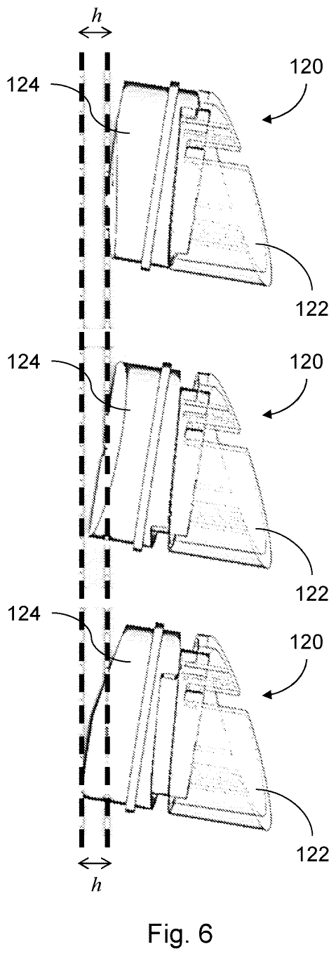

In the current example, the two portions 122, 124 are coupled via a snail coupling that is discussed in more detail below with reference to FIG. 6. The effect of this snail coupling is that a rotation of the mobile portion 124 around the rotational axis B-B results in a vertical movement of the mobile portion 124, relative to the stationary portion 122 and thus the keg surface 20. When moving downwards, the mobile portion 124 takes the transducer casing 132 and the transducer 130 down with it and pushes the transducer 130 firmly into the silicon covering 142 of the wave guide 140, 142. When moving upwards, the resiliency of the silicon covering 142 pushes the transducer 130 to move up together with the mobile portion 124.

When the transducer 130 is in the engaged state, the resilient wave guide 140, 142 may exert an inherent spring force onto the transducer 130 and the mobile portion 124. Preferably, the material properties and the geometry of the stationary portion 122 and the mobile portion 124 are such that the surface friction between the two portions 122, 124 is sufficient to withstand the spring force of the resilient wave guide 140, 142.

In other embodiments, a screw-type coupling is used instead of the snail cam coupling. Alternatively, the mobile portion 124 may simply be pushed downwards into or over the stationary portion 122 for engaging the transducer. In such push-button embodiments, the mobile portion 124 and/or the stationary portion 122 may comprise one or more latches to ensure that the stationary portion 122 can only be moved into one direction. The latches may be disengageable to allow the mobile portion 124 to move back into its original configuration wherein the transducer 130 is disengaged.

Regardless of the exact type of mechanical coupling, the transducer casing 132 and the stationary portion 122 together comprise at least one cooperating ridge and groove for guiding a linear motion of the transducer casing 132 relative to the stationary portion 122. The groove and ridge help to ensure that the transducer casing 132 cannot rotate relative to the stationary portion 122 and all movement will be in a straight line toward or away from the resilient wave guide 140, 142. This is especially advantageous in embodiments wherein the mobile portion 124 is configured to rotate relative to the stationary portion 122 and friction between the mobile portion 124 and the transducer casing 132 may cause the transducer casing to tend to rotate too.

FIG. 4 shows a partial cross section of another embodiment of the monitoring device 100 according to the invention. The main difference with the embodiment shown in FIG. 3 is that the transducer unit 120 is located within the bounds of the device housing 110 instead of at its outer edge (see FIG. 2). One or more spring elements 126 are installed between the device housing 110 and the mobile portion 124 to bias the mobile portion 124 towards the stationary portion 122 when the transducer is in the engaged state. This extra bias may help to ensure that the transducer 130 remains in the engaged state, even when the friction force between the stationary portion 122 and the mobile portion 124 is not always sufficient to avoid the resilient wave guide 140, 142 to push the transducer 130 back to the disengaged state.

FIG. 5a shows a perspective view of the monitoring device 100 of FIG. 4. FIG. 5b shows a perspective view of the same, but with the stationary portion 122 of the transducer unit 120 removed to reveal the resilient wave guide 140, 142.

FIG. 6 shows three different configurations of the transducer unit 120 of the monitoring devices 100 of FIGS. 2 to 5. The transducer unit 120 is shown here without the transducer 130, the transducer casing 132, and the resilient wave guide 140, 142 it can be seen to comprise in the cross sections shown in FIGS. 3 and 4. FIG. 6 shows how the snail cam coupling of the transducer unit 120 enables the mobile portion 124 to use a rotational motion to move up and down inside the stationary portion 122.

In the lowermost drawing, the transducer 130 is in the disengaged state with the mobile portion 124 in the position that is furthest away from the keg surface 20. In the middle drawing, the mobile portion 124 has been rotated over an angle of about 90°. The sloping bottom edge of the mobile portion 124 causes the mobile portion 124 to drop a little bit relative to its original position. In the top drawing, the mobile portion 124 has been rotated over a total angle of about 180°. There, the mobile portion 124 has arrived at its final position, closest to the keg surface 20. From this engaged position, the mobile portion 124 can than be rotated in the opposite direction in order to return to the disengaged configuration of the lowermost drawing.

As can be seen in FIG. 6, the roughly 180° rotation of the mobile portion 124 leads to a lowering or raising of the mobile portion 124 (and thus the transducer 130) over a height difference h. This height difference h may, for example be in the order of a few millimetres to 1 cm. In preferred embodiments, height difference h may be 2 mm, 3 mm, 4 mm, or 5 mm. It is noted that the geometry of the snail cam coupling shown here is just one of the many suitable examples. Other snail cams may use rotations that are smaller or larger than 180°. A similar effect can also be obtained with a screw-type coupling.

1. A device for monitoring a liquid in a container, the device comprising:
a device housing configured to be mounted to an external surface of the container,
a transducer, configured to emit sound waves or electromagnetic waves through the external surface to the liquid and to receive reflections of the emitted waves at the liquid,
a resilient wave guide with a top surface arranged to contact the transducer and a bottom surface arranged to contact the external surface of the container,
a transducer unit comprising the transducer and configured to enable the transducer to travel from a disengaged state to an engaged state, wherein the transducer is closer to the external surface when in the engaged state than when in the disengaged state, and
a controller, operatively coupled to the transducer to control the transducer and to process the received reflections.

2. A device for monitoring a liquid as claimed in claim 1, wherein the transducer unit is configured to enable the transducer to repeatedly travel back and forth between the engaged state and the disengaged state.

3. A device for monitoring a liquid as claimed in claim 1, wherein the transducer unit comprises a stationary portion, fixedly connected to the device housing, and a mobile portion, movingly coupled to the stationary portion, and mechanically coupled to the transducer, such that the transducer is brought to the engaged state by moving the mobile portion relative to the stationary portion.

4. A device for monitoring a liquid as claimed in claim 3, wherein the transducer is brought to the engaged state by a linear movement of the mobile portion relative to the stationary portion.

5. A device for monitoring a liquid as claimed in claim 3, wherein the transducer is brought to the engaged state by a rotational movement of the mobile portion relative to the stationary portion.

6. A device for monitoring a liquid as claimed in claim 5, wherein the stationary portion and the mobile portion are coupled via a snail cam coupling.

7. A device for monitoring a liquid as claimed in claim 5, wherein the stationary portion and the mobile portion are coupled via a screw coupling.

8. A device for monitoring a liquid as claimed in claim 5, wherein the mobile portion and the transducer are mechanically coupled in such a way that the transducer does not rotate with the mobile portion.

9. A device for monitoring a liquid as claimed in claim 8, wherein the transducer is held in a transducer casing, the transducer casing and the stationary portion together comprising at least one cooperating ridge and groove for guiding a linear motion of the transducer casing relative to the stationary portion.

10. A device for monitoring a liquid as claimed in claim 1, wherein the resilient wave guide comprises an elastomer.

11. A device for monitoring a liquid as claimed in claim 10, wherein the resilient wave guide comprises silicone.

12. A device for monitoring a liquid as claimed in claim 1, wherein the transducer is configured to emit ultrasonic waves.

13. A device for monitoring a liquid as claimed in claim 1, further comprising a wireless communication unit, operationally coupled to the controller for transmitting data based on the received reflections.

14. A container for storing a liquid, the container comprising a device for monitoring the liquid as claimed in claim 1, wherein the device housing of the device for monitoring the liquid is mounted to an external surface of the container.
